(19) United States
(12) Patent Application Publication
(10) Pub. No.: US 2014/0082092 A1
(43) Pub. Date: Mar. 20, 2014

(54) METHOD OF RESOLVING A CONTACT WHILE COMPOSING TEXT AND/OR EMAIL MESSAGE

(71) Applicants: Darryl Adderly, Morrisville, NC (US); Prasad Kashyap, Cary, NC (US); Brian J. Murray, Raleigh, NC (US); Wenjian Qiao, Cary, NC (US)

(72) Inventors: Darryl Adderly, Morrisville, NC (US); Prasad Kashyap, Cary, NC (US); Brian J. Murray, Raleigh, NC (US); Wenjian Qiao, Cary, NC (US)

(73) Assignee: International Business Machines Corporation, Armonk, NY (US)

(21) Appl. No.: 13/617,272

(22) Filed: Sep. 14, 2012

(51) Int. Cl. G06F 15/16

(52) U.S. Cl. 709/206

(57) ABSTRACT

Some embodiments of the inventive subject matter may include a method for sharing one or more data fields from within a contact in a contact list on an electronic computing device. The method can include receiving first user input requesting retrieval of the contact in the contact list. The method can include retrieving the contact in response to the user input. The method can include determining that the contact contains data fields, wherein the data fields include contact information for the contact. The method can include presenting one or more graphical user interface (GUI) controls for selecting at least one of the data fields within the contact. The method can include receiving, via the one or more GUI controls, second user input indicating selection of one or more of the data fields. The method can include sharing the one or more data fields associated with the contact.

### BACKGROUND

Embodiments of the inventive subject matter generally relate to the field of computing devices, and more particularly to contact lists stored within mobile computing devices.

Many computing devices allow users to store a contact list, where the contact list contains names, telephone numbers, addresses, email addresses, etc. of a user's contacts. Many contact lists are organized by the name of the contact. Typically, a user can open an address book or contact list and scroll through the contact entries. Upon coming to a desired entry, a user may typically access the entry by selecting the entry. When the entry is selected, the contact's information is displayed as data fields, such as telephone number, address, email address, etc. Typically, a user may then make a call, send a short message service (SMS or text) message, email, etc. to the contact by selecting the appropriate data field from within the contact's information.

Often times, users wish to share information from their contact list with another person. This is frequently done via short message service (SMS or text) message, multimedia messaging service (MMS), email, etc. Most mobile devices allow a user to share an entire contact entry (including all phone numbers, email addresses, alternate names for the contact, etc.). If a user wishes to share only some data fields associated with a contact, the process is more complex. To share limited contact information, a user may open their address book or contact list on their mobile device, find the desired contact, select the desired contact from the list which will display the contact's information, select the desired data fields to share by copying the desired information, return to the message, paste the contact information in the message, repeat the process to add additional information, and finally send the contact information.

### SUMMARY

Some embodiments of the inventive subject matter may include a method for sharing one or more data fields from within a contact in a contact list on an electronic computing device. The method can include receiving first user input requesting retrieval of the contact in the contact list. The method can include retrieving the contact in response to the user input. The method can include determining that the contact contains data fields, wherein the data fields include contact information for the contact. The method can include presenting one or more graphical user interface (GUI) controls for selecting at least one of the data fields within the contact. The method can include receiving, via the one or more GUI controls, second user input indicating selection of one or more of the data fields. The method can include sharing the one or more data fields associated with the contact.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an electronic computing device 102 presenting multiple data fields 108 for a contact which a user may select to share.

FIG. 2 is a flow diagram illustrating operations for enabling a user to share select data fields from a contact's information.

FIG. 3a depicts an electronic computing device 302 presenting a contact list 306.

FIG. 3b depicts an electronic computing device 308 presenting multiple data fields 314 for a contact 310 from the contact list 312.

FIG. 4 is a flow diagram illustrating operations for presenting multiple data fields of a contact's information for selection.

FIG. 5a depicts an electronic computing device 502 presenting multiple data fields 504 for a contact 506 from the contact list 508 and an option to share 510 contact information.

FIG. 5b depicts an electronic computing device 512 presenting a contact list 520 from which a user 524 may share contact information.

FIG. 6 is a block diagram of an electronic computing device 600, according to some embodiments of the inventive subject matter.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to selecting a specific phone number or email address, or sharing contact information with other users via a mobile phone, the same techniques can be employed with any computing device suitable to storing contact information. In other instances, well-known instruction instances, protocols, structures and techniques have not been shown in detail in order not to obfuscate the description.

Many users may have multiple data fields for each contact. For example, a user may have a home phone number, a mobile phone number, a work phone number, a personal email address, a work email address, etc. for a contact. To access these data fields and select the desired phone number at which to reach a contact, a user may have to scroll through a contact list (e.g., an address book), then select the desired contact to view the multiple data fields, and initiate communication by selecting one of the data fields. Embodiments of the inventive subject matter streamline this process by allowing a user to select a desired data field from the contact listing in the contact list. For example, in one embodiment that utilizes a touchscreen device, an address book may contain a plurality of soft buttons in the same row as each contact's name. The buttons allow the user to select between a plurality of phone numbers, email addresses, etc. for each contact without first selecting the contact entry in the address book. Hence, some embodiments enable the user to more quickly and efficiently initiate communications.

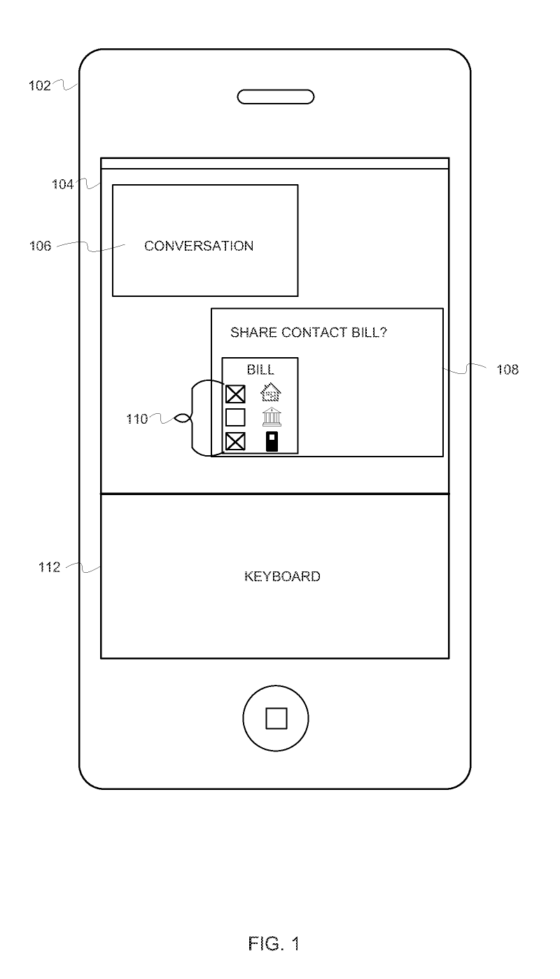

In other embodiments, the inventive subject matter may allow a user to utilize soft buttons to share portions of a contact's information. For example, a user may want to share a contact's information (e.g., a phone number) with a mutual friend. Embodiments allow the user to activate soft buttons to choose a portion of the contact information to share (e.g., phone number). In turn, embodiments can automatically send the selected contact information via a text message (e.g., Short Message Service Message). The following discussion of FIG. 1 describes such embodiments in more detail.

FIG. 1 depicts an electronic computing device 102 presenting multiple data fields 110 for a contact which a user may select to share. FIG. 1 shows a message (e.g., an SMS message) on a display 104. A previous texting conversation 106 appears in the display 104, along with a contact sharing prompt 108. The contact sharing prompt 108 includes a plurality of selection boxes 110 that enable the user to select certain contact information for sharing with others. The display also shows a keyboard 112. As depicted in FIG. 1, the user's contact “Bill” contains data fields 110 for a home phone number (top), work phone number (middle), and mobile phone number (bottom). As shown, the user has selected the home phone number and the mobile phone number to share (see “x” marks on top and bottom selection boxes). After the information is selected to be shared, the selected information is shared. In FIG. 1, the selected information is shared in connection with the previous texting conversation 106.

The following discussion will describe operations performed by some embodiments.

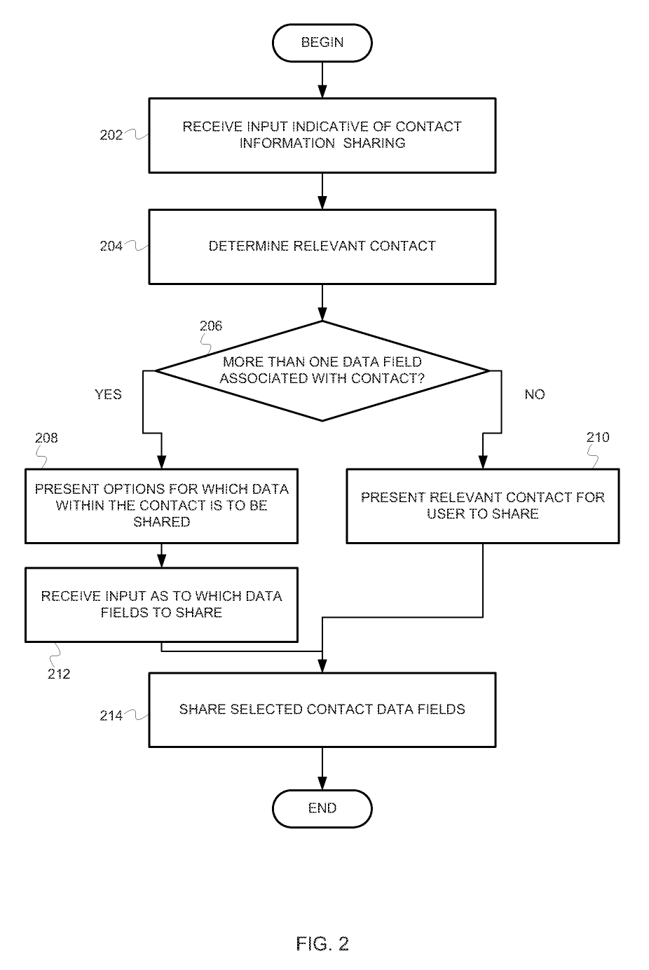

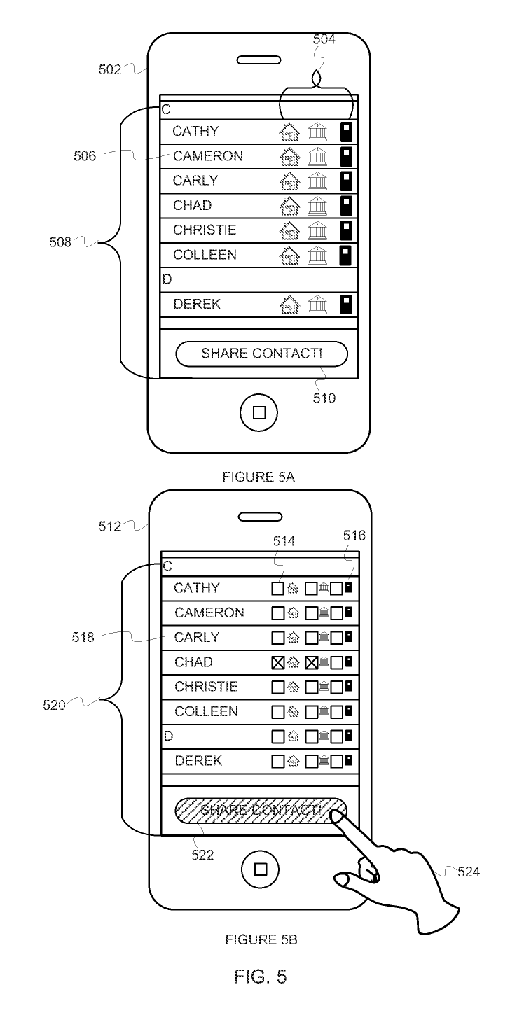

FIG. 2 is a flow diagram illustrating operations for enabling a user to share select data fields from a contact's information. The flow begins at block 202. At block 202, an electronic computing device receives input indicating that the user wants to share contact information. In some embodiments, the input may include beginning to type a contact's name, phone number, email address, etc. in an SMS, MMS, email, etc, message. In other embodiments, the input may include selecting a sharing option from a menu within the SMS, MMS, email, etc. message. In other embodiments, the input may include selecting a sharing option from within the contact list (see FIG. 5). The flow continues at block 204.

At block 204, the electronic computing device determines the contact relevant to the user's input. For example, if the user inputs the letters “‘D’ and ‘A,’” the electronic computing device may search the address book for contact names containing the combination “DA” (i.e. Dan, Dana, Danielle, etc.). The flow continues at block 206.

At block 206, the electronic computing device determines whether there are more than one data fields associated with the relevant contact. For example, the contact may contain data fields for multiple phone numbers, email addresses, physical addresses, etc. if the contact contains more than one data field, the flow continues at block 208. Otherwise the flow continues at block 210.

At block 208, the electronic computing device presents options allowing the user to select data fields to share. In some embodiments, the electronic computing device may present the options in the form of soft buttons, check boxes, or some other suitable selection element. The flow continues at block 212.

At block 212, the electronic computing device receives input from the user as to which of the contact data fields to share. The flow continues at block 214.

At block 214, the electronic computing device shares the selected data fields of the contact. In some embodiments, the computing device shares the contact's data fields by short message service (SMS or text) message, multimedia messaging service (MMS) message, email, etc. In some embodiments, the contact's data fields may be shared over a cellular telephone network, a local area network, a wide area network, a near field communication network, Bluetooth, etc.

After performing the operation at block 206, the “no” path leads to block 210. Therefore, after determining there is not more than one data field associated with the contact, the electronic computing device presents the relevant contact for the user to share. From block 210, the flow continues at block 214 (see above).

This discussion will proceed with a description additional embodiments that enable users to share contact information.

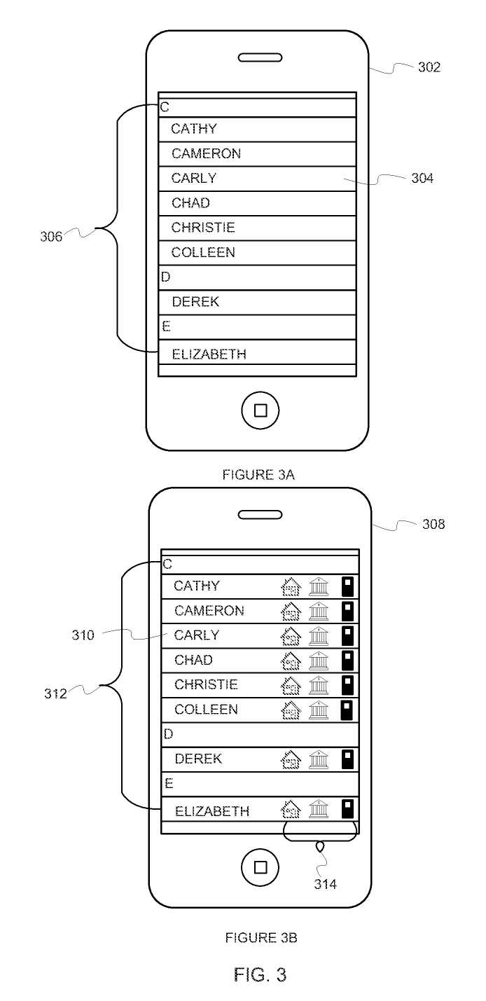

FIG. 3a depicts an electronic computing device 302 presenting a contact list 306. The user can select an individual contact 304 to view and to access the contact's data field(s). Sonic embodiments of the inventive subject matter augment user contact lists 306 by enabling users to select which contact information they want to share. FIG. 3b shows this in more detail.

FIG. 3b depicts an electronic computing device 308 presenting multiple data fields 314 for a contact 310 from a contact list 312. In one embodiment, the electronic computing device 308 displays a user's contact list, displaying individual contacts 310 and a plurality of soft buttons 314 which may allow a user to access the data fields within the contact 310 without first selecting the individual contact 310. As shown in FIG. 3b, in some embodiments, the soft buttons 314 may represent a home phone number (left), a work phone number (middle), and a mobile phone number (right). Additionally, in some embodiments, a user may be able to make phone calls, compose SMS, MMS, email messages, etc. from the contact list 312 by selecting the relevant soft button 314. For example, a user may be able to call a contact's 310 home phone by pressing the soft button 314 associated with the contact's 310 home phone number. A user may be able to call a contact's 310 mobile phone by pressing the soft button 314 associated with the contact's 310 mobile phone number. Additionally, a user may be able to compose an SMS message by pressing and holding the soft button 314 associated with the contact's 310 mobile phone number.

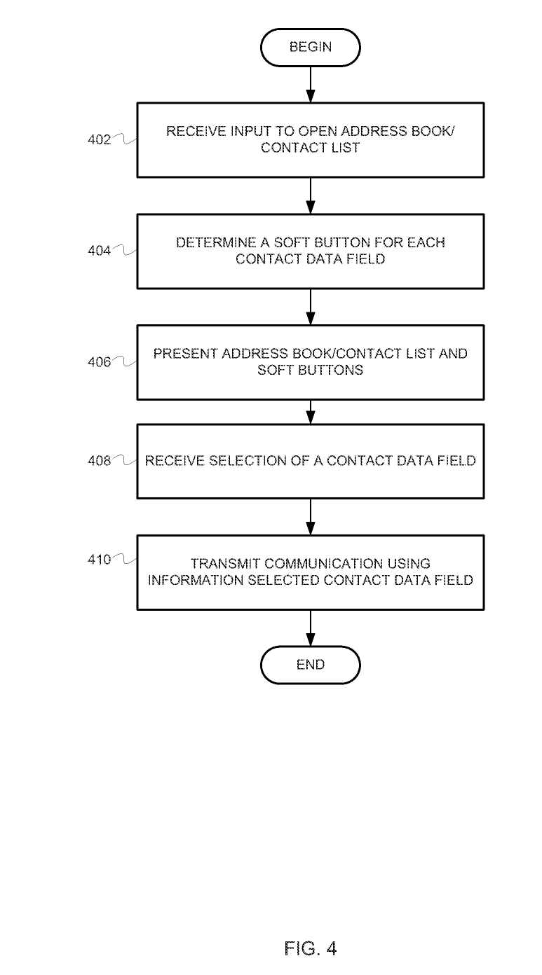

This discussion continues by describing operations for enabling a user to select between multiple data fields in a contact list. FIG. 4 describes such operations in greater detail.

FIG. 4 is a flow diagram illustrating operations for presenting multiple data fields of a contact's information for selection. The flow begins at block 402. At block 402, an electronic computing device receives user input to open an address book. In some embodiments, the address book may be stored on the electronic computing device. In other embodiments, the address book may be stored externally, and accessed by the electronic computing device over a network. The flow continues at block 404.

At block 404, the electronic computing device determines a graphical user interface (GUI) control (e.g., a soft button) for each contact data field. In some embodiments, the electronic computing device may populate soft buttons for each data field stored within a contact. In other embodiments, the electronic computing device may only populate soft buttons for predefined data fields. For example, the electronic computing device may be preconfigured to populate soft buttons only for a home phone number, mobile phone number, and work phone number. Further, in other embodiments, the user may be able to select the data fields from within a contact for which the electronic computing device will populate soft buttons. For example, a user could instruct the electronic computing device to populate soft buttons for a cell phone number and a personal email address for every contact in the contact list. Alternatively, a user could select specific data fields for which the electronic computing device would populate soft buttons for each contact. For example, the user might instruct the electronic computing device to populate soft buttons for a work phone number and a work email address for Contact X, and a home phone number, mobile phone number, and personal email address for Contact Y. The now continues at block 406.

At block 406, the electronic computing device presents the contact list or address book containing the soft buttons populated in block 404. In some instances, there may be a plurality of contacts having the same name. In such instances, the name identifier appearing on the display device may be accompanied by further information distinguishing between the contacts. The flow continues at block 408.

A block 408, the electronic computing device receives selection of a contact data field from a user. As noted above (see discussion of FIG. 3), in some embodiments, commands could consist of pressing the soft button to execute a call, pressing and holding the soft button to compose an SMS message, etc. The flow continues at block 410.

At block 410, the electronic computing device transmits communication using information from the selected data field. For example, pressing a soft button associated with a contact's home phone number data field may initiate a phone call to the contact's home phone number.

This discussion continues with a description of a computing device that may be used in some embodiments of the inventive subject matter.

FIG. 5a depicts an electronic computing device 502 presenting multiple data fields 504 for a contact 506 from the contact list 508 and an option to share 510 contact information. As discussed in FIG. 3b, the contact list 508 may include soft buttons 504 for each contact 506, where each soft button 504 is associated with a data field for the respective contact 506. Additionally, as shown in FIG. 5a, in some embodiments, the contact list 508 may include an option to share 510 contact information from within the contact list 508. For example, the contact list 508 may include a soft button, or some other appropriate means, with which a user may initiate a sequence to share contact information.

FIG. 5b depicts an electronic computing device 512 presenting a contact list 520 from which a user 524 may share contact information. In FIG. 51), the user 524 has selected the soft button 522 (as discussed in FIG. 5a) to initiate a sequence to share contact information. In some embodiments, the user 524 may first select a recipient contact 518. Upon initiation of the sharing sequence, the computing device 512 may display the contact list 520 including selection boxes 514, or other suitable means, allowing the user 524 to select the data fields 516 to share. Finally, the user 524 may select the soft button 522 to share the contact information. As shown in FIG. 5b, the user 524 has selected the home phone number and work phone number data fields 516, by selecting the respective selection boxes 514 (see “x” marks on left and middle selection boxes 514) associated with the contact 518 “Chad.”

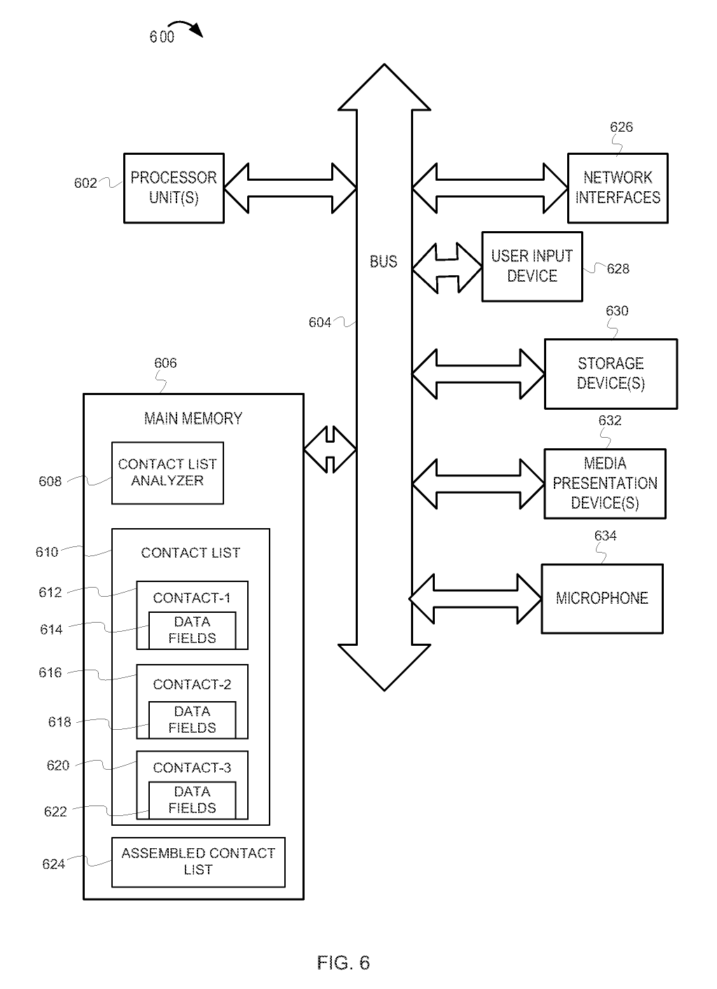

FIG. 6 is a block diagram of an electronic computing device 600 according to some embodiments of inventive subject matter. FIG. 6 depicts an example computer system. A computer system includes a processor unit 602 (possibly including multiple processors, multiple cores, multiple nodes, and/or implementing multi-threading, etc.). The computer system includes memory 606. The memory 606 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 604 (e,g., PCI, ISA, PCI-Express, HyperTransport®, InfiniBand®, NuBus, etc.), a network interface 626 (e.g., an ATM interface, an Ethernet interface, a Frame Relay interface, SONET interface, wireless interface, etc.), and a storage device(s) 630 (e.g., optical storage, magnetic storage, etc.). Any one of these functionalities may be partially (or entirely) implemented in hardware and/or on the processing unit 602. For example, the functionality may be implemented with an application specific integrated circuit, in logic implemented in the processing unit 602, in a co-processor on a peripheral device or card, etc. Further, realizations may include fewer or additional components not illustrated in FIG. 6 (e.g., video cards, audio cards, additional network interfaces, peripheral devices, etc.). The processor unit 602, the storage device(s) 630, and the network interface 626 are coupled to the bus 604. Although illustrated as being coupled to the bus 604, the memory 606 may be coupled to the processor unit 602. Additionally, the computer system may include a microphone 634.

In FIG. 6, the electronic computing device 600 includes an input device 628 to receive user input. In some embodiments, the user input device is a touchscreen, which may be part of a media presentation device 632. If the user input requests opening the contact list 610, the contact list analyzer 608 parses the contact list 610. It is unnecessary that the contact list analyzer 608 parse the contact list 610 each time the contact list 610 is opened. In some embodiments, a fully assembled contact list 624 containing GUI controls (e.g., soft buttons) may be populated only when the contact list 610 is modified. In such embodiments, an image of the assembled contact list 624 may be stored for quick access. Should it be necessary for the contact list analyzer 608 to analyze and compile the contact list 610 with soft buttons (assembled contact list 624), the contact list analyzer 608 can parse the contact list 610. In parsing the contact list 610, the contact list analyzer 608 can determine the number of data fields 614 associated with the contact entry 612. For example, as shown in FIG. 6, the contact list 610 contains 3 contacts 612, 616, 620, and associated data fields 614, 618, 622, respectively. The contact list analyzer 608 can populate soft buttons (or other GUI controls) for the appropriate data fields 614, creating the assembled contact list 624. The electronic computing device 600 can then present the assembled contact list 624 via a media presentation device 632.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system,” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including hut not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations (e.g., see FIGS. 2 & 4) and/or block diagrams of methods, apparatus (systems) e.g., see FIG. 5) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the inventive subject matter is not limited to them. In general, techniques for sharing contact information as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and ma fall within the scope of the inventive subject matter, in general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for sharing one or more data fields from within a contact in a contact list on an electronic computing device, the method comprising:
receiving first user input requesting retrieval of the contact in the contact list;
retrieving the contact in response to the user input;
determining that the contact contains data fields, wherein the data fields include contact information for the contact;
presenting one or more graphical user interface (GUI) controls for selecting at least one of the data fields within the contact;
receiving, via the one or more GUI controls, second user input indicating selection of one or more of the data fields; and
sharing the one or more data fields associated with the contact.

2. The method of claim 1, wherein a user can predetermine a default set of data fields to share.

3. The method of claim 1, wherein the data fields are shared in a short message service message.

4. The method of claim 1, wherein the data fields are shared in a multimedia messaging service message.

5. The method of claim 1, wherein the data fields are shared in an email message

6. The method of claim 1, wherein the data fields are shared over a local area network (LAN).

7. The method of claim 1, wherein the data fields are shared over a wide area network (WAN).

8. The method of claim 1, wherein the data fields are shared over a near field communication (NFC) network.

9. The method of claim 1, wherein the data fields are shared over a Bluetooth communication system.

10. A method for presenting a plurality of data fields associated with a contact in a contact list on an electronic computing device, the method comprising:
receiving input from a user requesting opening the contact list;
determining that a contact in the contact list contains data fields, wherein the data fields include contact information for the contact;
determining soft buttons for one or more of the data fields;
presenting the contact list and the soft buttons;
receiving, via interaction with one of the soft buttons, a selection of one of the data fields; and
transmitting a communication using information from the selected one of the data fields.

11. The method of claim 10, wherein the electronic computing device determines soft buttons for one or more predefined data fields.

12. The method of claim 10, wherein the user may select the data fields for which the electronic computing device determines the soft buttons.

13. A computer program product for sharing one or more data fields from within a contact in a contact list on an electronic computing device, the computer program product comprising:
a computer readable storage medium having computer usable program code embodied therewith, the computer usable program code comprising a computer usable program code configured to:
receive first user input requesting retrieval of the contact in the contact list;
retrieve the contact in response to the user input;
determine that the contact contains data fields, wherein the data fields include contact information for the contact;
present one or more graphical user interface (GUI) controls for selecting at least one of the data fields from within the contact;
receive, vie the one or more GUI controls, second user input indicating selection of one or more of the data fields; and
share the one or more data fields associated with the contact.

14. The computer readable storage medium of claim 13, wherein a user can predetermine a default set of data fields to share.

15. The computer readable storage medium of claim 13, wherein the data fields are shared in a short message service message.

16. The computer readable storage medium of claim 13, wherein the data fields are shared in a multimedia messaging service message.

17. The computer readable storage medium of claim 13, wherein the data fields are shared in one of an email message and a short message service message.

18. The computer readable storage medium of claim 13, wherein the data fields are shared over a local area network (LAN).

19. The computer readable storage medium of claim 13, wherein the data fields are shared over a wide area network (WAN).

20. The computer readable storage medium of claim 13, wherein he data fields are shared over a near field communication (NFC) network.
